(19) United States
(12) Patent Application Publication
(10) Pub. No.: US 2008/0119168 A1
(43) Pub. Date: May 22, 2008

(54) SYSTEM AND METHOD FOR USING TERMINAL RESOURCES TO CONSUME AND DISSEMINATE ADVERTISEMENTS

(75) Inventors: Lorant Farkas, Budapest (HU); Balazs Bakos, Torokbalint (HU); Csaba Edvi, Gyor (HU); Szabolcs Fodor, Budapest (HU); Attila Vangel, Budapest (HU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/562,806

(22) Filed: Nov. 22, 2006

(51) Int. Cl. H04Q 7/22; G09F 21/00; H04B 1/00

(52) U.S. Cl. 455/412.1; 455/414.1; 455/78

(57) ABSTRACT

A mobile terminal is provided that includes one or more resources configured for consuming an advertisement. In addition, the mobile terminal includes a processor configured for operating a client application that is configured for receiving an advertisement and directing the one or more resources to consume the advertisement. In response to consumption of the advertisement, the client application may receive a representation of a first benefit at the mobile terminal. The client application is also configured for forwarding the advertisement to another, destination mobile terminal for consumption thereat. In this regard forwarding the advertisement may include forwarding a representation of a second benefit. The representations are configured for a user of the mobile terminal to realize the first and second benefits.

### FIELD OF THE INVENTION

Embodiments of the present invention generally relate to systems and methods of consuming and disseminating advertisements, and more particularly, relate to systems and methods for using end-user terminal resources to consume and disseminate advertisements.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. The proliferation of local, regional, and global networks such as the Internet has availed a sea of information to society. These networking technologies have expanded to increasingly include wireless and mobile technologies. Through these networks, information can be downloaded to desktop systems, wireless systems, mobile systems, etc. For example, information available via the Internet can now be downloaded onto mobile wireless devices, such as cellular telephones, personal digital assistants (PDAs), laptop computers, etc.

Second generation wireless service, often referred to as 2G wireless service, is a current wireless service based on circuit-switched technology. In this regard, 2G systems, such as Global System for Mobile communications (GSM), use digital radio technology for improved quality and a broader range of services over first generation mobile technologies. Third generation wireless service, often referred to as 3G wireless service, refers to a set of digital technologies that promises improvements in capacity, speed and efficiency by deploying new packet-based transmission methodologies between terminals and the network. Users of 3G devices and networks will have access to multimedia services such as video-on-demand, video conferencing, and fast web access and file transfer. Existing and future services are, and will continue to be, provided by network operators who make services and applications available to mobile device users via the network.

As suggested, mobile wireless devices are quickly becoming ubiquitous. Many of these wireless devices support not only telephone calls, but also e-mail and other messaging (e.g., Short Messaging Service (SMS) messaging, Multimedia Messaging Service (MMS) messaging, etc.), Web access, video/audio transmissions, games and the like. This enhanced functionality has also led to the ability to display electronic advertisements on these devices. And although techniques have been developed for generally providing advertisements to mobile wireless devices, it is typically desirable to improve existing techniques.

### SUMMARY OF THE INVENTION

In view of the foregoing background, exemplary embodiments of the present invention provide a terminal, method and computer program product for using terminal resources to consume and disseminate advertisements. In accordance with exemplary embodiments of the present invention, a manufacturer or other merchant of a good or service may disseminate an advertisement to a terminal for consumption and dissemination using one or more terminal's resources. To facilitate a terminal user acquiescing to use of their terminal's resources for the consumption and dissemination of advertisements in accordance with exemplary embodiments of the present invention, the merchant may provide the terminal user with one or more incentives, such as monetary benefits, in exchange for consuming and/or disseminating an advertisement.

In accordance with one aspect of the present invention, a mobile terminal is provided that includes one or more resources configured for consuming an advertisement. In addition, the mobile terminal includes a processor configured for operating a client application that is configured for receiving an advertisement and directing the one or more resources to consume the advertisement. In response to consumption of the advertisement, the client application may receive a representation of a first benefit at the mobile terminal. For example, the client application may be configured for receiving a consumption certificate including a benefit code encoded using an identifier of the mobile terminal, where the benefit code represents a value of the first benefit or from which the first benefit is determinable.

The client application is also configured for forwarding the advertisement to another, destination mobile terminal for consumption thereat, where forwarding the advertisement includes forwarding a representation of a second benefit. For example, the client application may be configured for forwarding a forward certificate including a benefit code encoded using an identifier of the mobile terminal, where the encoded benefit code is further encoded using an identifier of the destination mobile terminal. Similar to the benefit code of the consumption certificate, the benefit code of the forward certificate may represent a value of the second benefit or from which the second benefit is determinable. Irrespective of the exact form of the representations, however, the representations may be configured for a user of the mobile terminal to realize the first and second benefits.

The client application may receive the advertisement in a number of different manners. In this regard, the client application may be configured for receiving an advertisement from a source mobile terminal, and including receiving a representation of a second benefit. Similar to before, for example, the client application may be configured for receiving a forward certificate including a benefit code encoded using an identifier of the source mobile terminal, where the benefit code represents a value of the second benefit or from which the second benefit is determinable. Here, however, the encoded benefit code may be further encoded using an identifier of the mobile terminal. The client application may then be configured for forwarding the advertisement to the destination terminal, including the respective representation of the second benefit. More particularly, for example, the client application may be configured for forwarding the advertisement, and including a forward certificate with the further encoded benefit code, which may be even further encoded using an identifier of the destination mobile terminal.

In accordance with other aspects of the present invention, a method and computer program product are provided for using terminal resources to consume and disseminate advertisements. Exemplary embodiments of the present invention therefore provide a terminal, method and computer program product for using terminal resources to consume and disseminate advertisements. As indicated above and explained below, exemplary embodiments of the present invention may therefore solve the problems identified by prior techniques, and/or may provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for consuming and disseminating an advertisement, according to exemplary embodiments of the present invention;

FIG. 2 is a schematic block diagram of an entity configured for operating as a network node, in accordance with exemplary embodiments of the present invention;

FIG. 3 is a schematic block diagram more particularly illustrating a mobile terminal network node according to exemplary embodiments of the present invention;

FIG. 4 is a functional block diagram of a system for consuming and disseminating an advertisement, in accordance with an exemplary embodiment of the present invention;

FIG. 5 is a flowchart of a method of consuming and disseminating an advertisement, in accordance with one exemplary embodiment of the present invention; and

FIG. 6 another a functional block diagram of a system for consuming and disseminating an advertisement, in accordance with an exemplary embodiment of the present invention.

### DETAILED DESCRIPTION OF THE INVENTION

The present invention now will be described more fully hereinafter with reference to the accompanying drawings, in which exemplary embodiments of the invention are shown. This invention may, however, be embodied in many different forms and should not be construed as limited to the exemplary embodiments set forth herein; rather, these exemplary embodiments are provided so that this disclosure will be thorough and complete, and will fully convey the scope of the invention to those skilled in the art. Like numbers refer to like elements throughout.

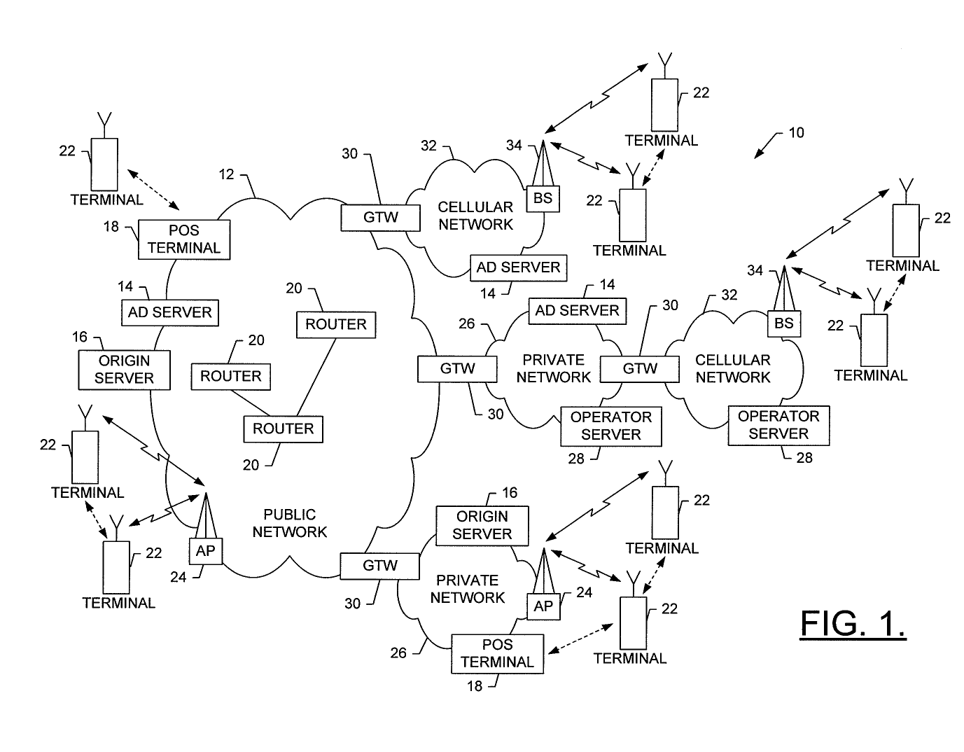

Referring to FIG. 1, an illustration of one type of system that may benefit from embodiments of the present invention is provided. As shown, the system 10 includes a public network 12, such as a public Internet Protocol (IP) network like the Internet. The public network includes a number of network nodes, each of which typically comprise a processing element such as a server computer, router computer, personal computer, laptop computer or the like, configured for communicating within or across the public network. More particularly, the public network can include one or more network nodes comprising server processors, workstations or the like (hereinafter individually referred to as a “server.”) One or more of the servers may operate as an ad server 14 or an origin server 16, as explained below. The public network can also include one or more network nodes that may operate as a point-of-sale (POS) terminal 18. Further, the public network can include a number of routers 20 through which communications are passed through the public network. In addition, the public network can include one or more network nodes comprising mobile terminals 22, each of which are configured for communicating within or across the public network.

The terminals 22 can comprise, for example, mobile telephones, portable digital assistants (PDAs), pagers, laptop computers, smart cards and other types of electronic systems. The terminals may be coupled to one or more other nodes of the public network 12, such as other terminals, POS terminals 22 or the like, and may thereby access the public network via the respective node(s). To more generally facilitate the terminals accessing the public network, the public network can include one or more wireless access points (AP's) 24, each of which can be coupled to one or more terminals. The terminals and other nodes (e.g., other terminals, POS terminals, AP's, etc.) can be configured to communicate with one another in accordance any of a number of different wireless networking techniques including, for example, wireless personal area network (WPAN) communication techniques, such as radio frequency (RF), Bluetooth (BT), infrared (IrDA) or the like, and/or wireless local area network (WLAN) communication techniques, IEEE 802.11 techniques or the like. In accordance with exemplary embodiments of the present invention, one or more terminals are configured for operating as a client to communicate with one or more other terminals, servers and/or POS terminals. It should be appreciated, however, that one or more terminals can additionally, or alternatively, be configured for operating as a server or POS terminal.

In addition to the public network 12, the system 10 can include one or more private networks 26, such as local area networks (LANs). Each private network, like the public network, can include a number of network nodes. Also, like the public network, the network nodes of one or more private networks can include one or more servers (e.g., ad servers 14, origin servers 16, etc.) and, if so desired, one or more routers (not shown). Further, the network nodes of one or more private networks can include one or more servers of operators of the respective network(s), referred to herein as operator servers 28. One or more private networks can also, like the public network, include one or more network nodes comprising one or more mobile terminals 22, each of which can be coupled to another terminal, POS terminal 18 and/or AP 24, for example. Further, to facilitate communications between network nodes of the public network and network nodes of the private networks, each private network can further include a gateway processor (GTW) 30 interconnecting the public network and the private network.

The system 10 can also include one or more mobile or cellular networks 32. The cellular networks can comprise one or more of a number of different mobile networks. In this regard, the cellular networks can comprise any of a number of first-generation (1G), second-generation (2G), 2.5G and/or third-generation (3G) cellular networks, and/or any of a number of other cellular networks configured for operating in accordance with exemplary embodiments of the present invention. For example, each cellular network can comprise a GSM (Global System for Mobile Communication), IS-136 (Time Domain Multiple Access—TDMA), IS-95 (Code Division Multiple Access—CDMA), or EDGE (Enhanced Data GSM Environment) network. Alternatively, one or more of the cellular networks can comprise GPRS (General Radio Packet Service) or GPRS-based (e.g., Universal Mobile Telecommunications System—UMTS) networks.

Like the public and private networks 12, 26, the cellular networks 24 can also include one or more network nodes. In this regard, the network modes of each cellular network can include mobile terminals configured for communicating within and/or across a respective cellular network. More particularly, the cellular networks can include one or more servers (e.g., operator servers 28, etc.) and, if so desired, routers (not shown), as with the public and private networks. In addition, the cellular networks can include one or more network nodes comprising terminals 22. To couple each terminal to the cellular network, however, the cellular network includes a base site or base station (BS) 34 (although one or more terminals may be additionally or alternatively coupled to one or more other terminals). As will be appreciated, the BS is a part of the cellular network, which can also include other elements required to operate the cellular network, such as a mobile switching center (MSC) (not shown). Similar to before, to facilitate communications between network nodes of the public and/or private networks and network nodes of the cellular networks, each cellular network can further include a GTW 30 interconnecting the cellular network and a public or private network.

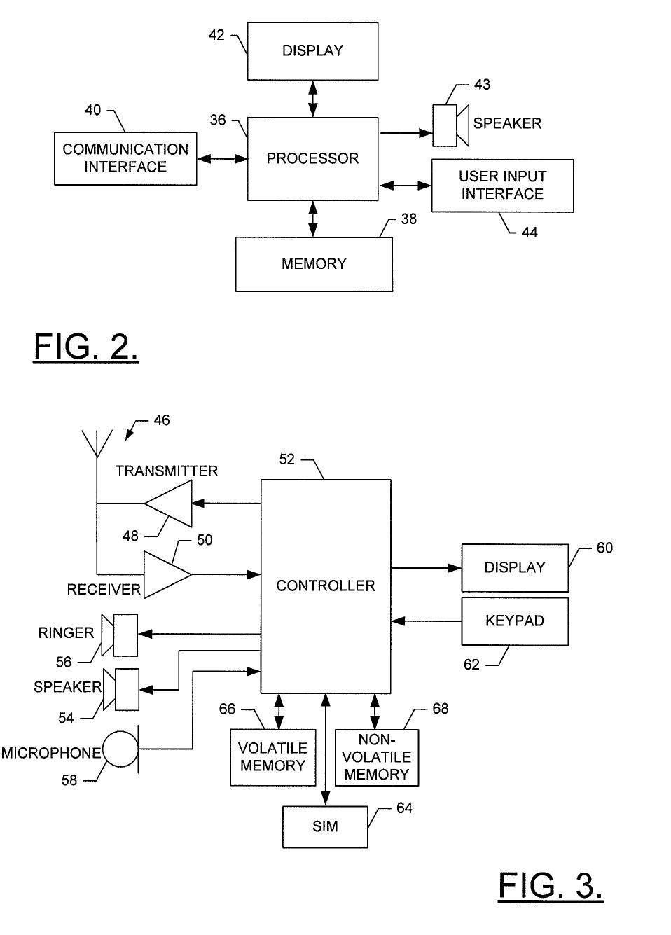

Reference is now made to FIG. 2, which illustrates a block diagram of an entity configured for operating as a network node (e.g., ad server 14, origin server 16, POS terminal 18, terminal 22, operator server 28, etc.) within the public network 12, private network(s) 26 or cellular network(s) 32, in accordance with one exemplary embodiment of the present invention. Although shown as separate entities, in some exemplary embodiments, one or more entities may support one or more of the network nodes, logically separated but co-located within the entit(ies). For example, a single entity may support a logically separate, but co-located, server (e.g., ad server, origin server, operator server, etc.) and terminal. Additionally or alternatively, for example, a single entity may support a logically separate, but co-located server (e.g., ad server, origin server, operator server, etc.) and POS terminal.

The entity configured for operating as a network node includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 36 connected to a memory 38. The memory can comprise volatile and/or non-volatile memory, and typically stores content, data or the like. For example, the memory typically stores content transmitted from, and/or received by, the entity. Also for example, the memory typically stores software applications, instructions or the like for the processor to operate the entity in accordance with exemplary embodiments of the present invention.

In addition to the memory 38, the processor 36 can also be connected to at least one interface or other means for displaying, transmitting and/or receiving data, content or the like. In this regard, the interface(s) can include at least one communication interface 40 or other means for transmitting and/or receiving data, content or the like, as well as at least one user interface that can include a display 42, speaker 43 and/or a user input interface 44. The user input interface, in turn, can comprise any of a number of devices allowing the entity to receive data from a user, such as a keypad, a touch display, a joystick or other input device.

Reference is now made to FIG. 3, which more particularly illustrates one type of terminal 22 that would benefit from exemplary embodiments of the present invention. It should be understood, however, that the terminal illustrated and hereinafter described is merely illustrative of one type of terminal that would benefit from embodiments of the present invention and, therefore, should not be taken to limit the scope of the present invention. While several exemplary embodiments of the terminal are illustrated and will be hereinafter described for purposes of example, other types of terminals, such as those indicated above, can readily employ embodiments of the present invention.

The terminal 22 includes various means for performing one or more functions in accordance with exemplary embodiments of the present invention, including those more particularly shown and described herein. It should be understood, however, that the MN may include alternative means for performing one or more like functions, without departing from the spirit and scope of the present invention. More particularly, for example, as shown in FIG. 3, in addition to an antenna 46, the terminal may include a transmitter 48, a receiver 50, and a controller 52 or other processor that provides signals to and receives signals from the transmitter and receiver, respectively. These signals include signaling information in accordance with the air interface standard of the applicable cellular system, and also user speech and/or user generated data. In this regard, the terminal can be configured for operating with one or more air interface standards, communication protocols, modulation types, and access types. More particularly, the terminal can be configured for operating in accordance with any of a number of 1G, 2G, 2.5G and/or 3G cellular networks, and/or any of a number of other cellular networks configured for operating in accordance with exemplary embodiments of the present invention. For example, the terminal may be configured for operating in accordance with 2G wireless communication protocols GSM, IS-136 (TDMA) and/or IS-95 (CDMA). Additionally or alternatively, for example, the terminal may be configured for operating in accordance with 2.5G wireless communication protocols GPRS, EDGE or the like. Further, for example, the terminal may be configured for operating in accordance with 3G wireless communication protocols such as UMTS network.

It is understood that the controller 52 includes the circuitry required for implementing the audio and logic functions of the terminal 22. For example, the controller may be comprised of a digital signal processor device, a microprocessor device, and various analog-to-digital converters, digital-to-analog converters, and other support circuits. The control and signal processing functions of the terminal are allocated between these devices according to their respective capabilities. The controller can additionally include an internal voice coder (VC), and may include an internal data modem (DM). Further, the controller may include the functionality to operate one or more software programs, which may be stored in memory (described below). For example, the controller may be configured for operating a connectivity program, such as a conventional Web browser. The connectivity program may then allow the terminal to transmit and receive Web content, such as according to HTTP and/or the Wireless Application Protocol (WAP), for example.

The terminal 22 may also comprise a user interface including a conventional earphone or speaker 54, a ringer 56, a microphone 58, a display 60, and a user input interface, all of which are coupled to the controller 52. The user input interface, which allows the terminal to receive data, can comprise any of a number of devices allowing the terminal to receive data, such as a keypad 62, a touch display (not shown) or other input device. In exemplary embodiments including a keypad, the keypad includes the conventional numeric (0-9) and related keys (#, *), and other keys used for operating the terminal. Although not shown, the terminal can include a battery, such as a vibrating battery pack, for powering the various circuits that are required to operate the terminal, as well as optionally providing mechanical vibration as a detectable output.

Although not shown, the terminal 22 can further include one or more means for locally sharing data with one or more other network nodes, such as other terminals, POS terminals 18, AP's 24 or the like. The sharing of data, as well as the remote sharing of data, can also be provided according to a number of different wireless networking techniques, including WPAN and/or WLAN communication techniques. For example, the terminal can include a radio frequency (RF) transceiver configured for sharing data with other radio frequency transceivers, and/or with a Radio Frequency Identification (RFID) transponder tag, as such is known to those skilled in the art. Additionally, or alternatively, the terminal may include a Bluetooth transceiver for sharing data using Bluetooth brand wireless technology developed by the Bluetooth Special Interest Group. Further, for example, the terminal may share data using any of a number of different WLAN techniques such as IEEE 802.11 techniques or the like.

The terminal 22 can further include memory, such as a subscriber identity module (SIM) 64, a removable user identity module (R-UIM) or the like, which typically stores information elements related to a mobile subscriber. In addition to the SIM, the terminal can include other removable and/or fixed memory. In this regard, the terminal can include volatile memory 66, such as volatile Random Access Memory (RAM) including a cache area for the temporary storage of data. The terminal can also include other non-volatile memory 68, which can be embedded and/or may be removable. The non-volatile memory can additionally or alternatively comprise an EEPROM, flash memory or the like. The memories can store any of a number of pieces of information, and data, used by the terminal to implement the functions of the terminal. For example, the memories can store one or more identifiers, such as an international mobile equipment identification (IMEI) code, international mobile subscriber identification (IMSI) code, terminal integrated services digital network (MSISDN) code (mobile telephone number), Session Initiation Protocol (SIP) address, one or more Media Access Control (MAC) addresses or the like, configured for uniquely identifying the terminal and/or one or more components of the terminal (e.g., Bluetooth transceiver, etc.). As explained below, the memories can also store one or more software applications configured for operating on the terminal.

As explained in the background section, many mobile wireless devices support not only telephone calls, but also e-mail and other messaging (e.g., Short Messaging Service (SMS) messaging, Multimedia Messaging Service (MMS) messaging, etc.), Web access, video/audio transmissions, games and the like. This enhanced functionality has also led to the ability to display electronic advertisements on these devices. And although techniques have been developed for generally providing advertisements to mobile wireless devices, it is typically desirable to improve existing techniques.

Exemplary embodiments of the present invention therefore provide a system, terminal, method and computer program product for using the resources of terminals 22 to disseminate and consume advertisements. In accordance with exemplary embodiments of the present invention, a manufacturer or other merchant of a good or service may disseminate an advertisement to a terminal for consumption using one or more resources of the terminal. These resources may include, for example, display resources (e.g., display 42, display 60, etc.), speaker resources (e.g., speaker 43, speaker 54, etc.) and/or storage resources (e.g., memory 38, volatile memory 66, non-volatile memory 68, etc.) of a terminal.

In addition to using terminal resources to consume the advertisement, terminal resources may be used to further disseminate the advertisement from the terminal to one or more other terminals. In this regard, the resources by which advertisements may be disseminated may include networking resources (e.g., WPAN, WLAN, etc.) of a terminal. The terminal may thereby forward those advertisements to other terminals for consumption by other terminal users.

To facilitate a terminal user acquiescing to use of their terminal's resources for the consumption advertisements in accordance with exemplary embodiments of the present invention, the merchant may provide the terminal user with an incentive for consumption of the advertisement. The merchant may also provide the terminal user with an incentive for further dissemination or forwarding of the advertisement to one or more other terminals, and/or for receiving a further disseminated advertisement, thereby facilitating the terminal user acquiescing to use of their terminal's networking resources for the dissemination of advertisements. In this regard, an incentive may be provided to a user during or after consumption of an advertisement at their respective terminal 22. An incentive may also be provided to a user during or after purchase of a qualifying good or service (e.g., good or service featured in the advertisement—advertised good/service) by a user of another terminal that directly/indirectly received the advertisement from their terminal.

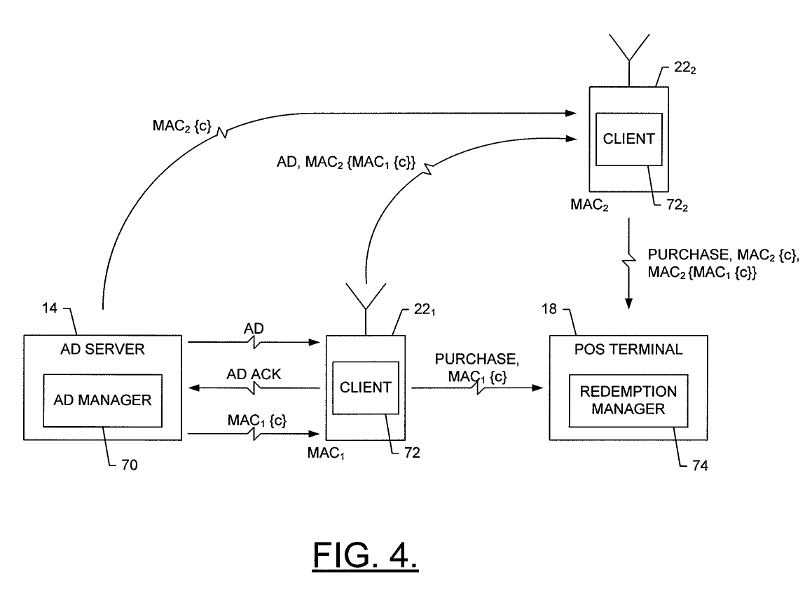

Reference is now made to FIG. 4, which illustrates a functional block diagram of an ad server 14 of a merchant disseminating an advertisement (AD) to a terminal 22 (the terminal being shown as terminal 22₁) for consumption and further dissemination to one or more other terminals (one being shown as terminal 22₂), and providing incentives to the terminal user for the advertisement's consumption and further dissemination. As shown, the ad server is configured for operating a software application, such as an ad manager 70, for disseminating the advertisement to the terminal and providing the incentive to use one or more resources of the terminal to consume the advertisement. The terminal, in turn, is configured for operating a software application, such as a client 72 (e.g., client 72₁ for terminal 22₁, and client 72₂ for terminal 22₂), for receiving the disseminated advertisement, directing consumption and further dissemination of the advertisement by one or more resources of the terminal, and receiving incentives for the advertisement's consumption and further dissemination.

The incentives provided by the ad manager 70, and received by the client 72, may include any of a number of different entities tending to entice the terminal user into directing use of resource(s) of the terminal to consume and/or further disseminate the advertisement. For example, the incentives may include monetary benefits, such as discounts for the purchase of one or more goods and/or services (including, e.g., accessing a resource). In this regard, the incentives may include a first benefit provided in exchange for consuming the advertisement, and one or more second benefits provided in exchange for further disseminating the advertisement. Thus, at some point subsequent to the ad manager providing the client with one or more incentives including one or more benefits (e.g., discount(s) for the purchase of good(s)/service(s)), the client may be configured for communicating with a POS terminal 18 to realize the benefit(s). In this regard, the POS terminal may be configured for operating a software application, such as a redemption manager 74, for managing realization of any first and/or second benefits, such as by applying any first and/or second discounts to the purchase of respective good(s) and/or service(s).

As shown and described herein, the ad manager 70, client 72 and redemption manager 74 comprise software generally stored and operated by the ad server 14, terminal 22 and POS terminal 18, respectively. It should be understood, however, that the ad manager, client and/or redemption manager can alternatively comprise firmware or hardware, without departing from the spirit and scope of the present invention. Also, as shown and described herein, advertisements, incentives (e.g., discounts) or the like may be disseminated, provided, downloaded, uploaded, exchanged or otherwise transferred from one network node to another network node. It should be understood, however, that the terms “disseminating,” “providing,” “downloading,” “uploading,” “exchanging” and “transferring” can be used herein interchangeably, and that disseminating, providing, downloading, uploading, exchanging or transferring advertisements, incentives or the like can include, for example, moving or copying such content, without departing from the spirit and scope of the present invention.

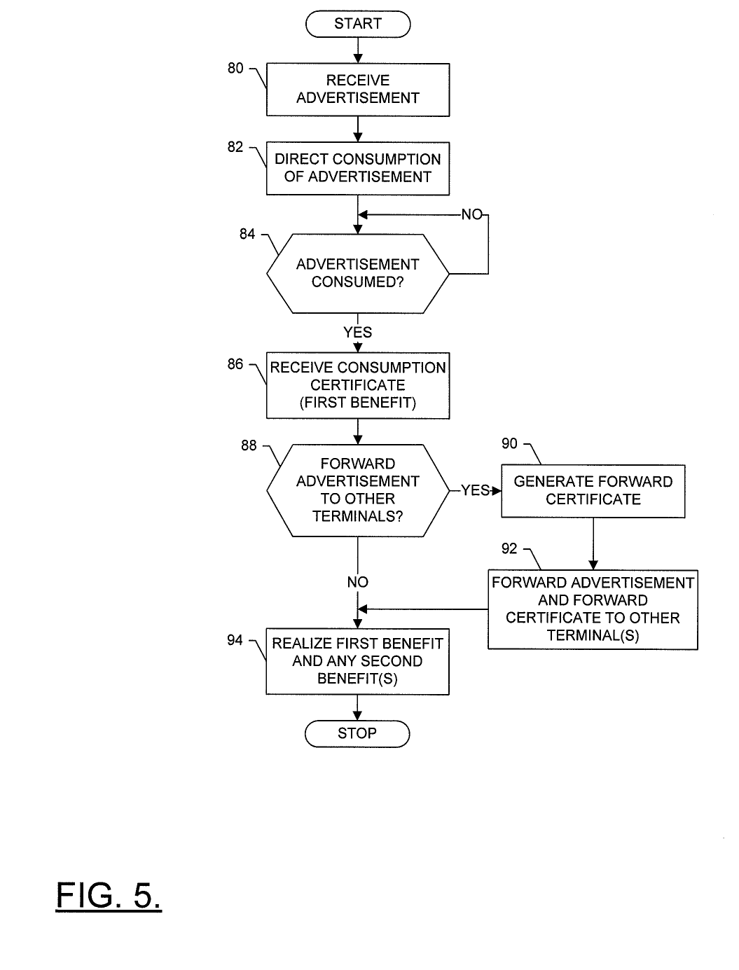

More particularly, and with further reference to the flowchart of FIG. 5, a method of using one or more terminal resources to consume and disseminate an advertisement, in accordance with one exemplary embodiment of the present invention, may include the ad manager 70 disseminating, and the client 72 receiving, an advertisement (AD) for a good or service, as shown in block 80. In this regard, receiving an advertisement may be initiated in any of a number of different manners. In one embodiment, for example, the terminal user may operate a Web browser to access a Web page (e.g., a Web page operated by the merchant) for subscribing to the receipt of advertisements, whether from the terminal 22 or another computing device. From the Web page, the terminal user may then subscribe to receive one or more advertisements at one or more instances. In another embodiment, for example, a service or resource operator (or provider) may invite the terminal user to receive and consume an advertisement before and/or after receiving access to the respective resource or service. More particularly, for example, the operator of a private or cellular network 26, 32 may invite the terminal user to receive and consume an advertisement before and/or after receiving access to the respective network, such as via a respective operator server 28. And in yet an even more particular example, a cellular network operator may invite the terminal user to receive and consume an audio advertisement before and/or after placing a cellular telephone call from or accepting a cellular telephone call at the terminal. In such instances, the terminal user may actively accept the invitation by providing user input to the terminal (e.g., pressing a key of the terminal's keypad) and, by extension, the respective network operator; or passively accept the invitation by failing to provide user input.

Irrespective of how receiving the advertisement is initiated, the client 72 may receive the advertisement at one or more instances, such as at single instance, periodically, before/after accessing a network, before/after accessing a service, or the like. Further, the client may receive the advertisement in any of a number of different forms and in any of a number of different manners. For example, the client may receive the advertisement as a textual, graphical and/or audio message via one or more messaging techniques including, for example, e-mail, SMS, MMS, voicemail or the like. Also, for example, the client may receive the advertisement, including a textual, graphical and/or audio content, in a document formatted (e.g., Hypertext Markup Language—HTML) for display in a window (e.g., popup window) of a Web browser operable by the terminal; and may receive the document in a manner for receiving such documents, such as in accordance with HTTP. Further, for example, the client may receive the advertisement as streaming text, graphics and/or audio, such as in accordance with the Real-Time Transport Protocol (RTP).

Irrespective of the form or manner of receiving the advertisement, as or after the client receives the advertisement, the client 72 may direct consumption of the advertisement by one or more resources of the terminal 22, as shown in block 82. The client may automatically direct consumption of the advertisement. In other instances, however, the client may notify the terminal user of receipt of the advertisement, such as by means of a visual and/or audio alert, so that the terminal user may direct the client to direct consumption of the advertisement at the discretion of the terminal user.

As indicated above, the advertisement may include textual, graphical and/or audio content. And as such, a number of different resources of the terminal 22 may be called upon to consume the advertisement including, for example, display resources (e.g., display 42, display 60, etc.), speaker resources (e.g., speaker 43, speaker 54, etc.) and/or storage resources (e.g., memory 38, volatile memory 66, non-volatile memory 68, etc.). More particularly, for example, the client may direct the terminal's display to present textual and/or graphical content of an e-mail, SMS, MMS or other message, alone or in combination directing the terminal's speaker to output of any audio portion of that message; or direct the terminal's speaker to output audio content of a voicemail message. Also, for example, the client may direct the terminal's display to present a textual and/or graphical content of a document formatted for display by a Web browser, or streaming text and/or graphics, alone or in combination directing the terminal's speaker to output any audio portion of that message or streaming content. In accordance with exemplary embodiments of the present invention, the client may direct the display to present textual and/or graphical content of the advertisement in all or a portion of the display, at one or more instances of time, statically or with one or more effects (e.g., floating, blinking, etc.). In a more particular example, the client may direct the display to present textual and/or graphical content of the advertisement as a screensaver. Further, the client may direct resources of the terminal 22 directly or via a separate application for managing or otherwise directing consumption of such content (e.g., e-mail, SMS, MMS or other message viewer, voicemail player, Web browser, etc.).

In addition to or in lieu of directing consumption of the advertisement by resources such as display and/or speaker resources, the client 72 may direct storage of all or a portion of the advertisement. The stored advertisement may then be included in a selectable list of stored advertisements or other content (e.g., e-mail, SMS, MMS, voicemail or other messages, etc.) for subsequent selection by the terminal user to direct consumption thereof. In this regard, the client may subsequently further disseminate the advertisement to other terminals 22 (one other terminal being shown as terminal 222), which may similarly include respective clients (one other client being shown as client 722), as explained further below. Also, the client may defer further consumption of the advertisement by display and/or speaker resources, such as in those instances in which the client notifies the terminal user of receipt of the advertisement and the terminal user desires to defer further consumption of the advertisement. In such instances, however, the client, ad manager 70 or other entity remote from the terminal may further notify or otherwise alert the terminal user at one or more instances after storing and before further consumption of the advertisement (the ad manager in appropriate circumstances being notified by the client of consumption of the advertisement, as explained below). These notifications may generally indicate the existence of a stored, but not yet consumed, advertisement; and, if so desired, may further indicate an expiration of any incentive being offered for its consumption.

Irrespective of exactly how the client 72 directs consumption of the advertisement, and how the terminal's resources consume the advertisement, after the terminal's resources consume all or a portion of the advertisement, the ad manager 70 may provide, and the client may receive, an incentive for consuming the advertisement, as shown in blocks 84 and 86. In this regard, the ad manager may be made aware of consumption of the advertisement in any of a number of different manners. In one embodiment, for example, the client may send a notification (e.g., AD ACK) to the ad manager to thereby notify the ad manager of the terminal resources' consumption of all or a portion of the advertisement. Then, in response to the notification, the ad manager may provide the incentive to the client.

As indicated above, an incentive may include a monetary benefit. More particularly, for example, the incentive may include a discount for the purchase of a good of a merchant, which may be purchased via the terminal or in any of a number of other manners. Also, for example, the incentive may include a discount for accessing a private network 26, such as to in turn access a public network 12 (e.g., Internet). Also, for example, the incentive may include a discount for accessing a cellular network 32, such as to place or accept a cellular telephone call. Further, for example, the incentive may include a discount for accessing a messaging service, such as an e-mail, SMS, MMS, voicemail or other messaging service.

Further, the benefit (e.g., discount) may have a fixed or dynamically adjustable value, and may be represented as an absolute monetary value or a relative value (e.g., percentage of the cost of a respective good or service). In this regard, the benefit may have a dynamically adjustable value based on a number of different parameters related to consumption of the advertisement. For example, the value of the benefit may increase or decrease in proportion with an amount of the terminal's resources used to consume the advertisement. More particularly, for example, the benefit value may increase or decrease in proportion to an amount of the terminal's display (e.g., display 42, display 60, etc.) used to display textual and/or graphical content of the advertisement. Also, for example, the benefit value may increase in proportion with an amount of time the terminal's resources consume the advertisement, or in proportion with an amount of the advertisement consumed by the terminal's resources. Further, for example, the benefit may have a predefined value that decreases in proportion with an amount of time between the client 72 receiving the advertisement and directing the terminal's resources to consume the advertisement.

The ad manager 70 of the ad server 14 may provide the incentive, and the client 72 of the terminal 22 may receive the incentive, in any of a number of different manners. In one embodiment, for example, the ad sever may provide the incentive, including its benefit (first benefit), to the client in the form of a “consumption certificate.” In this regard, the consumption certificate may include a benefit code (“c”) representing the value of the benefit or from which the benefit is determinable, and may also include one or more tags or other values representing the advertisement and/or advertised good/service, the name of the merchant offering the benefit, the date of issuance of the benefit or the like. Further, the benefit code and other tags may (but need not) be encoded using an identifier associated with or otherwise assigned to the terminal 22, which may be known or otherwise communicated to the ad manager (e.g., within the AD ACK). As shown in FIG. 4, for example, the consumption certificate may include a benefit code “c” encoded with a MAC address that identifies a Bluetooth transceiver of the terminal (shown as “MAC{c}” or, more particularly for terminal 22₁, as “MAC₁{c}”). It should be understood, however, that the identifier with which the benefit code is encoded may comprise the MAC address of the terminal, or any of a number of other components of the terminal; or may comprise any of a number of other identifiers of the terminal (e.g., IMEI code, IMSI code, MSISDN code, etc.).

In addition to or in lieu of directing consumption of the advertisement (and, in exchange, receiving an incentive), the client 72 may direct resources of the terminal, such as networking resources (e.g., WPAN, WLAN, etc.), to further disseminate the advertisement to one or more other terminals, or more particularly to the client of one or more other terminals, as shown in block 88. In such instances, the client further disseminating or otherwise forwarding the advertisement may operate as a “source” client (e.g., client 72₁) of a “source” terminal (e.g., terminal 22₁), and the client to which the advertisement is disseminated or otherwise forwarded may operate as a “destination” client (e.g., client 72₂) of a “destination” terminal (e.g., terminal 22₂). In this regard, the source client may direct further dissemination of the advertisement at any of a number of different instances after receiving the advertisement including, for example, after the terminal's resources consume the advertisement and the client receives a respective consumption certificate in response thereto. The destination client(s) of the other terminal(s) may receive the advertisement in any of a number of different manners, including manners similar to that of the source client receiving the advertisement from the ad manager 70 of the ad server 14. The destination client(s) may then direct consumption of the advertisement using the resources of their respective destination terminals, and in exchange, receive consumption certificate(s) (e.g., MAC₂ {c}) from the ad server, such as in a manner similar to that of the source client (shown, e.g., without the destination client sending an AD ACK to the ad manager). In lieu of receiving the advertisement directly from the source client, the source client may provide, and the destination client(s) may receive, a link or other address of the ad manager from which the destination client(s) may receive the advertisement, such as in the same manner as the source client. Thus, as explained herein, further disseminating or otherwise forwarding an advertisement may refer to the advertisement itself or a link or other address to the advertisement.

In addition to the advertisement, the source client 72 (e.g., client 72₁) may provide the destination client(s) (e.g., client 72₂) with a marker or other entity by which the source client and, if so desired, the destination client may subsequently receive a further incentive, including for example a benefit (second benefit), for having further disseminated the advertisement, as explained below. The marker or other entity may be provided with the advertisement (or link thereto) in any of a number of different manners. In one embodiment, for example, the source client may provide the destination client(s) with a marker in the form of a “forward certificate.” As with the consumption certificate, the forward certificate may include a benefit code (representing the value of the second benefit or from which the second benefit is determinable) and other tags encoded using an identifier of the source terminal 22, where the consumption certificate received for consuming an advertisement may in various instances comprise the content of a forward certificate for further disseminating the respective advertisement. If so desired, the encoded benefit code and other tags may be further encoded using an identifier associated with or otherwise assigned to the respective destination terminal (e.g., MAC₂ {MAC₁ {c}} for destination terminal 22₂), which may be known or otherwise communicated to the source client (e.g., during establishment of a Bluetooth communication link). Again, it should be understood that the identifier of the destination client may comprise any of a number of different identifiers of the destination terminal, or one or more components of the destination terminal.

After the client 72 of the terminal 22 directs consumption and/or further dissemination of the advertisement, the respective terminal user may desire to realize the benefit (first benefit) of the consumption certificate, and the benefits (second benefits) of any forward certificates disseminated by the respective client, as shown in block 94. The terminal user may redeem the benefit(s) in any of a number of different manners. In one embodiment, for example, the terminal user may redeem the benefit of a consumption certificate by directing the terminal in communication with a POS terminal 18 to effectuate a purchase of a good or service to which the benefit(s) may be applied, such as to reduce the cost of the respective good or service. In this regard, during communication with the POS terminal to effectuate the purchase of a good or service, the client may provide the redemption manager 74 of the respective POS terminal with a consumption certificate including a benefit (first benefit). The redemption manager may then use the respective terminal's identifier (or component identifier) to decode and verify the benefit code (“c”) and other tags, the terminal's identifier (or component identifier) being known or otherwise communicated to the redemption manager. The redemption manager may then remit the benefit to the terminal user, such as in the form of a discount for the good or service being purchased.

Similar to redeeming the benefit of a consumption certificate, the benefit of a forward certificate may be redeemed in any of a number of different manners, and by a source terminal user and/or destination terminal user. In one embodiment, for example, following receipt of a forward certificate from the source terminal (e.g., terminal 22₁), the destination terminal (e.g., terminal 22₂) may communicate with a POS terminal 18 to effectuate a purchase of a good or service. During the purchase, the destination client (e.g., client 72₂) may provide the redemption manager 74 of the respective POS terminal with the forward certificate including a benefit (second benefit), and if appropriate, may provide the forward certificate along with a consumption certificate provided to the respective destination terminal (from the ad manager 70). Similar to before, the redemption manager may then use the respective destination terminal's identifier (or component identifier) to decode and verify the benefit code (“c”) and other tags in the consumption certificate, the destination terminal's identifier (or component identifier) being known or otherwise communicated to the redemption manager.

As to the forward certificate, the benefit code and other tags may be encoded with the source terminal's identifier (or component identifier), and then further encoded with the destination terminal's identifier (or component identifier), as is indicated above. Thus, the redemption manager 74 may further use the destination terminal's identifier (or component identifier), as well as the source terminal's identifier (or component identifier) to decode and verify the benefit code (“c”) and other tags in the forward certificate, the source terminal's identifier (or component identifier) also being known or otherwise communicated to the redemption manager. The redemption manager may then remit the benefit (first benefit) of the consumption certificate and, if desired, the benefit (second benefit) of the forward certificate to the destination terminal user, such as in the form of a discount for the good or service being purchased. Further, the redemption manager may remit or otherwise hold (e.g., retain benefit code “c” in memory) the benefit (second benefit) of the forward certificate to or for the source terminal user. If held, the benefit may be subsequently remitted to the source terminal user, such as during effectuation of the purchase of a good and/or service by the source terminal user with the respective POS terminal 18.

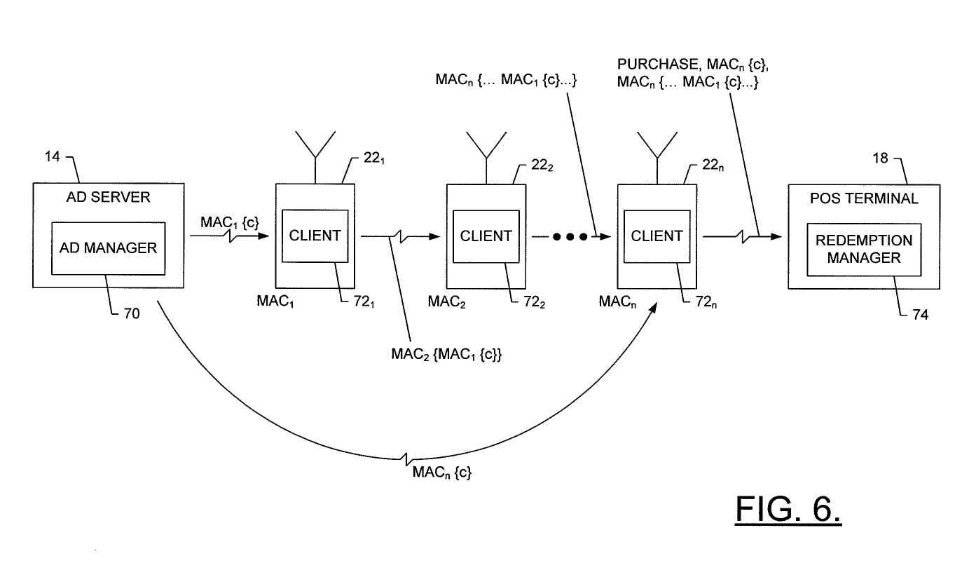

As explained above, a source terminal (e.g., terminal 22₁) may further disseminate an advertisement to one or more destination terminals (e.g., terminal 22₂), and provide a forward certificate along with the advertisement. It should further be noted that any one or more of these destination terminals may even further disseminate the advertisement to one or more additional terminals (e.g., terminal 22ₙ), as shown in FIG. 6. In this regard, the destination terminal may operate as a subsequent source terminal with respect to the one or more additional terminals, which may operate as subsequent destination terminals. And in such instances, the forward certificate from the subsequent source terminal to subsequent destination may include, as its content, the forward certificate received by the subsequent source terminal. The respective forward certificate may then be encoded using an identifier associated with or otherwise assigned to the respective subsequent destination terminal (e.g., MACₙ { . . . {MAC₁ {c} . . . }} for subsequent destination terminal 22ₙ), which may be known or otherwise communicated to the subsequent source client (e.g., during establishment of a Bluetooth communication link). Thus, for example, the forward certificate to the third terminal in a chain of forwarding an advertisement may include, as content, the forward certificate to the second terminal (e.g., MAC₂ {MAC₁ {c}}), encoded with an identifier of the third terminal (e.g., MAC₃ {MAC₂ {MAC₁ {c}}}). Similarly, for example, the forward certificate to the fourth terminal in a chain of forwarding an advertisement may include, as content, the forward certificate to the third terminal (e.g., MAC₃ {MAC₂ {MAC₁ {c}}}), encoded with an identifier of the fourth terminal (e.g., MAC₄ {MAC₃ {MAC₂ {MAC₁ {c}}}}). During realization of the benefit of the forward certificate by the user of the last terminal in the chain (i.e., the terminal who provides the forward certificate to the redemption manager 74), the redemption manager may decode and verify the benefit code (“c”) and other tags in the forward certificate using the identifiers (or component identifiers) of the terminals in the chain of forwarding the respective certificate. The users of one or more, if not all, of the terminals in the chain may then realize a benefit, such as the same or a similar benefit to that realized by the last terminal user.

It should further be noted that in various instances a consumption certificate or forward certificate may not be necessary to realize a benefit for the consumption or further dissemination of an advertisement. In this regard, consider a terminal user being invited to receive and consume an audio advertisement before and/or after placing a cellular telephone call from or accepting a cellular telephone call at the terminal. In such instances, the terminal user may immediately realize the benefit following consumption of the audio advertisement by being permitted to place or accept a respective call, without the ad manager providing the respective terminal 22 with a consumption certificate.

Further, it should be noted that in various instances, the ad server 14 and POS terminal 18 may communicate with one another before, after and/or during effectuation of the advertisement dissemination and benefit redemption of exemplary embodiments of the present invention. For example, the POS terminal (the redemption manager 74) may notify the ad server (ad manager 70) of the time and manner of the terminal user redeeming its respective benefits. Additionally or alternatively, for example, the POS terminal may communicate with the ad server to verify one or more benefits before their redemption by a terminal.

According to one exemplary aspect of the present invention, the functions performed by one or more of the entities of the system, such as the ad server 14, origin server 16, POS terminal 18, terminal 22, and/or operator server 28, may be performed by various means, such as hardware and/or firmware, including those described above, alone and/or under control of a computer program product. The computer program product for performing one or more functions of exemplary embodiments of the present invention includes a computer-readable storage medium, such as the non-volatile storage medium, and software (e.g., ad manager 70, client 72, redemption manager 74, etc.) including computer-readable program code portions, such as a series of computer instructions, stored in the computer-readable storage medium.

In this regard, FIGS. 4, 5 and 6 are functional block diagrams and a flowchart of systems, methods and program products according to exemplary embodiments of the present invention. It will be understood that each block or step of the functional block diagrams and flowchart, and combinations of blocks in the functional block diagrams and flowchart, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the functional block diagrams' and flowchart's block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the functional block diagrams' and flowchart's block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the functional block diagrams' and flowchart's block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific exemplary embodiments disclosed and that modifications and other embodiments are intended to be included within the scope of the appended claims. Although specific terms are employed herein, they are used in a generic and descriptive sense only and not for purposes of limitation.

What is claimed is:

1. A mobile terminal comprising:
one or more resources configured for consuming an advertisement; and
a processor configured for operating a client application, wherein the client application is configured for receiving an advertisement and directing the one or more resources to consume the advertisement, and in response thereto, receiving a representation of a first benefit at the mobile terminal, and
wherein the client application is configured for forwarding the advertisement to another, destination mobile terminal for consumption thereat, forwarding the advertisement including forwarding a representation of a second benefit, the representations being configured for a user of the mobile terminal to realize the first and second benefits.

2. A mobile terminal according to claim 1, wherein the client application being configured for receiving a representation of a first benefit includes the client application being configured for receiving a consumption certificate including a benefit code encoded using an identifier of the mobile terminal, the benefit code representing a value of the first benefit or from which the first benefit is determinable.

3. A mobile terminal according to claim 1, wherein the client application being configured for forwarding a representation of a second benefit includes the client application being configured for forwarding a forward certificate including a benefit code encoded using an identifier of the mobile terminal, the encoded benefit code being further encoded using an identifier of the destination mobile terminal, the benefit code representing a value of the second benefit or from which the second benefit is determinable.

4. A mobile terminal according to claim 1, wherein the client application being configured for receiving an advertisement includes the client application being configured for receiving an advertisement from a source mobile terminal, receiving the advertisement including receiving a representation of a second benefit, and
wherein the client application being configured for forwarding the advertisement includes the client application being configured for forwarding the representation of the second benefit.

5. A mobile terminal according to claim 4, wherein the client application being configured for receiving a representation of a second benefit includes the client application being configured for receiving a forward certificate including a benefit code encoded using an identifier of the source mobile terminal, the encoded benefit code being further encoded using an identifier of the mobile terminal, the benefit code representing a value of the second benefit or from which the second benefit is determinable.

6. A mobile terminal according to claim 5, wherein the client application being configured for forwarding the representation of the second benefit includes the client application being configured for forwarding a forward certificate including the further encoded benefit code, the further encoded benefit code being even further encoded using an identifier of the destination mobile terminal.

7. A mobile terminal comprising:
a first means for receiving an advertisement at a mobile terminal;
a second means for directing one or more resources of the mobile terminal to consume the advertisement;
a third means for receiving a representation of a first benefit in response to consumption of the advertisement; and
a fourth means for forwarding the advertisement to another, destination mobile terminal for consumption thereat, forwarding the advertisement including forwarding a representation of a second benefit, the representations being configured for a user of the mobile terminal to realize the first and second benefits.

8. A mobile terminal according to claim 7, wherein the third means is configured for receiving a consumption certificate including a benefit code encoded using an identifier of the mobile terminal, the benefit code representing a value of the first benefit or from which the first benefit is determinable.

9. A mobile terminal according to claim 7, wherein the fourth means is configured for forwarding a forward certificate including a benefit code encoded using an identifier of the mobile terminal, the encoded benefit code being further encoded using an identifier of the destination mobile terminal, the benefit code representing a value of the second benefit or from which the second benefit is determinable.

10. A mobile terminal according to claim 7, wherein the first means is configured for receiving an advertisement from a source mobile terminal, receiving the advertisement including receiving a representation of a second benefit, and
wherein the fourth means is configured for forwarding the advertisement including forwarding the representation of the second benefit.

11. A mobile terminal according to claim 10, wherein the first means is configured for receiving a forward certificate including a benefit code encoded using an identifier of the source mobile terminal, the encoded benefit code being further encoded using an identifier of the mobile terminal, the benefit code representing a value of the second benefit or from which the second benefit is determinable.

12. A mobile terminal according to claim 11, wherein the fourth means is configured for forwarding a forward certificate including the further encoded benefit code, the further encoded benefit code being even further encoded using an identifier of the destination mobile terminal.

13. A method comprising:
receiving an advertisement at a mobile terminal;
consuming the advertisement at the mobile terminal, and in response thereto, receiving a representation of a first benefit at the mobile terminal; and
forwarding the advertisement to another, destination mobile terminal for consumption thereat, forwarding the advertisement including forwarding a representation of a second benefit, the representations being configured for a user of the mobile terminal to realize the first and second benefits.

14. A method according to claim 13, wherein receiving a representation of a first benefit comprises receiving a consumption certificate including a benefit code encoded using an identifier of the mobile terminal, the benefit code representing a value of the first benefit or from which the first benefit is determinable.

15. A method according to claim 13, wherein forwarding a representation of a second benefit comprises forwarding a forward certificate including a benefit code encoded using an identifier of the mobile terminal, the encoded benefit code being further encoded using an identifier of the destination mobile terminal, the benefit code representing a value of the second benefit or from which the second benefit is determinable.

16. A method according to claim 13, wherein receiving an advertisement comprises receiving an advertisement from a source mobile terminal, receiving the advertisement including receiving a representation of a second benefit, and
wherein forwarding the advertisement includes forwarding the representation of the second benefit.

17. A method according to claim 16, wherein receiving a representation of a second benefit comprises receiving a forward certificate including a benefit code encoded using an identifier of the source mobile terminal, the encoded benefit code being further encoded using an identifier of the mobile terminal, the benefit code representing a value of the second benefit or from which the second benefit is determinable.

18. A method according to claim 17, wherein forwarding the representation of the second benefit comprises forwarding a forward certificate including the further encoded benefit code, the further encoded benefit code being even further encoded using an identifier of the destination mobile terminal.

19. A computer program product comprising at least one computer-readable storage medium having computer-readable program code portions stored therein, the computer-readable program code portions comprising:
a first executable portion for receiving an advertisement at a mobile terminal;
a second executable portion for directing one or more resources of the mobile terminal to consume the advertisement;
a third executable portion for receiving a representation of a first benefit in response to consumption of the advertisement; and
a fourth executable portion for forwarding the advertisement to another, destination mobile terminal for consumption thereat, forwarding the advertisement including forwarding a representation of a second benefit, the representations being configured for a user of the mobile terminal to realize the first and second benefits.

20. A computer program product according to claim 19, wherein the third executable portion is configured for receiving a consumption certificate including a benefit code encoded using an identifier of the mobile terminal, the benefit code representing a value of the first benefit or from which the first benefit is determinable.

21. A computer program product according to claim 19, wherein the fourth executable portion is configured for forwarding a forward certificate including a benefit code encoded using an identifier of the mobile terminal, the encoded benefit code being further encoded using an identifier of the destination mobile terminal, the benefit code representing a value of the second benefit or from which the second benefit is determinable.

22. A computer program product according to claim 19, wherein the first executable portion is configured for receiving an advertisement from a source mobile terminal, receiving the advertisement including receiving a representation of a second benefit, and
wherein the fourth executable portion is configured for forwarding the advertisement including forwarding the representation of the second benefit.

23. A computer program product according to claim 22, wherein the first executable portion is configured for receiving a forward certificate including a benefit code encoded using an identifier of the source mobile terminal, the encoded benefit code being further encoded using an identifier of the mobile terminal, the benefit code representing a value of the second benefit or from which the second benefit is determinable.

24. A computer program product according to claim 23, wherein the fourth executable portion is configured for forwarding a forward certificate including the further encoded benefit code, the further encoded benefit code being even further encoded using an identifier of the destination mobile terminal.
